(19) United States
(12) Patent Application Publication
(10) Pub. No.: US 2002/0162437 A1
(43) Pub. Date: Nov. 7, 2002

(54) Stripping device for die cutting machine

(76) Inventor: Toshinaga Urabe, Sagamihara-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/135,435

(22) Filed: May 1, 2002

(30) Foreign Application Priority Data
May 7, 2001 (JP) 2001-174840
Sep. 3, 2001 (JP) 2001-312029

(51) Int. Cl. B26F 1/40; B26D 7/02

(52) U.S. Cl. 83/132; 83/142; 83/375

(57) ABSTRACT

A stripping device for die cutting machine comprising a female die 2 which has female holes 21 corresponding to a plurality of external wastes 111 or internal wastes 112 on the same straight line; a male die 3 which has male pins 31 corresponding to the female holes 21; and a lower plate receiving member 43 for housing a catching plate 411 having pin catching projections 412 corresponding to the male pins 31, and cutouts 413 corresponding to a product 1 or a product bridge 1A, the lower plate receiving member 43 having spring housing holes 415 for housing springs 4153 to vertically move the catching plate 411.

### BACKGROUND OF THE INVENTION

1. Field of the Invention

The present invention relates to a plain die cutting machine used in the corrugated fiberboard container manufacturing industry, particularly, a stripping device used therein. With a plain die cutting machine, a paper board or a corrugated fiberboard is cut with dies. FIG. 1 is a plan view showing a blank of gang product 1 that has been formed by die cutting. This product 1 has an internal hole 12. The cutting blade of a blanking die (steel rule die) forms cut lines 13. The die cutting machine is provided with not only a device for blanking, but also a receiving pin device with which, in the process subsequent to blanking, a waste 11 of the product 1 is sandwiched between a female die 2 and a male pin 31 to be forcedly transferred to under the female die 2 for release. The present invention provides an improvement of the female die 2 and such receiving pin device.

2. Prior Art

FIG. 3-1 to FIG. 3-3 illustrate the process of stripping when a conventional stripping device is used with a plain die cutting machine. FIG. 3-1 to FIG. 3-3 are a sectional view, illustrating the relationship among a four, i.e., a male die 3, a product 1 to be stripped, a male pin 31 and a receiving pin 41, the latter two sandwiching a waste 11 of the product 1 for removal. The process of stripping is explained with reference to FIG. 3-1 to FIG. 3-3 as follows: FIG. 3-1 shows the state in which the product 1 has been transferred to the stripping device. The waste 11 is positioned on a female hole 21 in a female die 2. The outline of the female hole 21 is offset by approx. 1.5 mm from the outline of the waste 11 of the product 1.

The male pin 31 is positioned to the center of the waste 11, the receiving pin 41 of a lower pin supporter 4 being accurately positioned to the male pin 31. FIG. 3-2 shows the state in which the male die 3 is lowered, the lower pin supporter 4 being raised, with the receiving pin 41 being raised to the top of the female hole 21 to sandwich the waste 11 with male pin 31. Sponges 32 hold down the outside of the waste 11 on the surface of the female die 2. FIG. 3-3 shows the state in which the male die 3 and the lower pin supporter 4 are lowered together, the receiving pin 41 being pressed by a spring loaded inside the lower pin supporter 4. To prevent the products 1 from being disjoined when being transferred to the stripping process following the blanking process, the cutting blade of the blanking die is provided with nicks. The male pin 31 sandwiches the waste 11 with the receiving pin 41 to cut the uncut portions formed by the nicks from the cut lines 13 of the product 1 for removal. When the waste 11 is brought to near the bottom of the female hole 21, the male die 3 is raised, the lower pin supporter 4 being further lowered, which results in the waste 11 being released to be dropped downward.

The male pins 31 are mounted to the upper metallic frame of the stripping device one by one. In recent years, to reduce the time required for mounting, a plywood as shown in FIG. 3-1 to FIG. 3-3 is previously imbedded into the male die 3 which has been cut by use of CO₂ laser, and the male die 3 is mounted to the metallic frame. However, the lower pin support 4 cannot be previously mounted to the plywood as the male die 3 can. This is because the waste 11 is dropped.

Then, before die cutting, the female die 2 and the male die 3 are first set, which is followed by the operator getting in under the machine to align the receiving pin 41 with the male pin 31 above it and mount the lower pin support 4 to the metallic frame. This results in the machine being stopped during that operation. In addition, when a number of wastes 11 must be dropped as shown in FIG. 1, a extremely long period of time is required. To avoid such operation to be made under the machine, various systems which eliminate the need for using the lower pin support 4 have been proposed. For example, Patent Publication No. 5-96498/1993, 8-90493/1996, and 7-132497/1995 have been proposed. However, each requires a special male die and a female die, being not completely satisfactory.

The present invention has solved this problem by improving the female die 2 and the lower pin supporter 4 such that they can be mounted extremely easily.

### SUMMARY OF THE INVENTION

A stripping device for die cutting machine which strips a plurality of internal wastes 112 by using a catching plate 411 according to the present invention as shown in FIG. 7 instead of a conventional receiving pin 41, comprising a female die 2 which has a connecting groove 22 for connecting a plurality of female holes 21 to strip a plurality of internal wastes 112 and bridge portions 23 on an extension line from both ends thereof; and a lower plate receiving member 43 for housing a catching plate 411 having cutouts 413 corresponding to the connecting groove 22 and the bridge portions 23, the lower plate receiving member 43 having spring housing holes 415 for housing springs 4153 to vertically move the catching plate 411.

### BRIEF DESCRIPTION OF THE DRAWINGS

FIG. 1 shows a blank of gang product that has been formed by die cutting;

FIG. 2 is a plan view of an embodiment according to the present invention;

FIG. 3-1 to FIG. 3-3 are a sectional view of a conventional stripping device;

FIG. 4 is a plan view illustrating the positional relationship between the male die and the female die according to the present invention;

FIG. 5 is a plan view illustrating the female die according to the present invention;

FIG. 6 is a perspective view specifically showing the details of the present invention;

FIG. 7 shows a catching plate according to the present invention;

FIG. 8 shows a blank of gang product that has been formed by die cutting; and

FIG. 9 is a plan view showing a female die, a male pin and a catching plate in an embodiment according to the present invention.

### DESCRIPTION OF THE PREFERRED EMBODIMENTS

Hereinbelow, embodiments of the present inventions will be described in detail with reference to attached drawings.

(Embodiment 1)

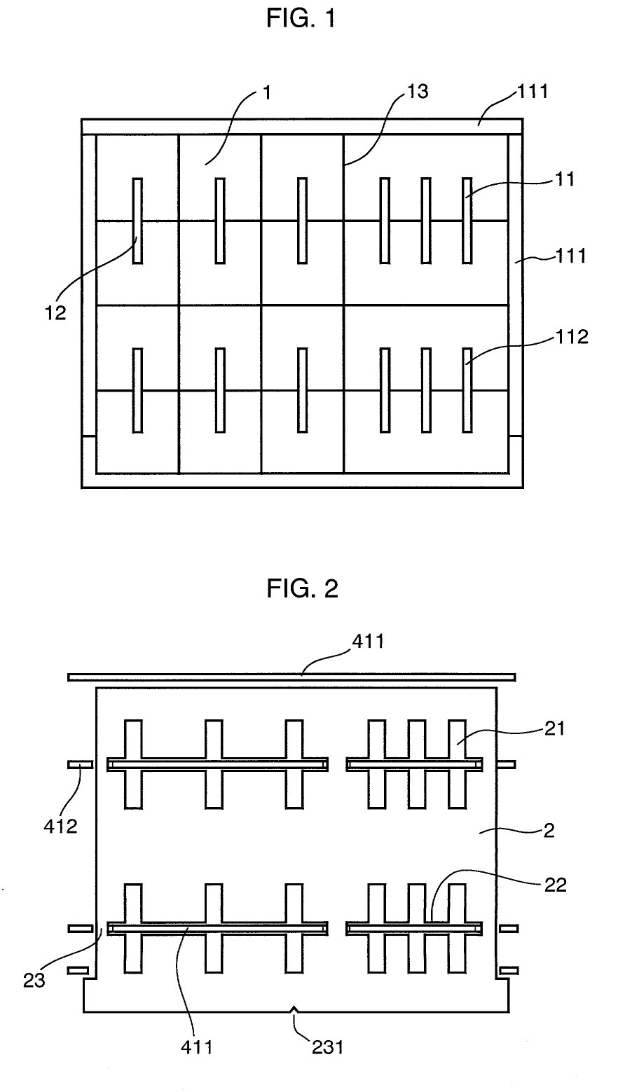

FIG. 1 shows a blank of gang partition that has been just formed by die cutting, but is extremely difficult to be stripped. The reason why this blank is extremely difficult to be stripped is that the geometry thereof causes an internal waste 112 to get loose from a male pin 31.

A product 1 comprises the internal waste 112, which corresponds to an internal hole 12 in the partition product 1, and an external waste 111, which surrounds the blank. The product 1 and these wastes are formed by cut lines 13. To prevent the product 1 and the wastes from being disjointed when they are transferred to the subsequent stripping section after being produced in the die cutting section, they are jointed to one another by the uncut portions (not shown) which have been formed by the nicks of the cutting blade. In FIG. 1, the bottom portion provides the gripping side.

FIG. 2 is a plan view of an embodiment according to the present invention. Six female holes 21 are connected to one another by a connecting groove 22. The connecting groove 22 has a groove width of 3 mm. Two connecting grooves 22 are formed in the direction perpendicular to the gripper. A female die 2 is produced by cutting a plywood of 12 mm in thickness with a CO₂ gas laser to the geometry. The groove width of the female hole 21 is wider than that of the hole 12 in the product 1 by 1 mm per side. On the other hand, the outline of the female die 2, which is used for dropping off the surrounding external wastes 111, is offset by 1 mm from the outline of the product 1 toward the inside thereof.

FIG. 2 is also a plan view illustrating the positional relationship between the female die 2 according to the present invention and a catching plate 411. On the gripping sides a centering mark 231 for the “centering system”, which has been proposed by Bobst Co. in Switzerland, is provided in the female die 2.

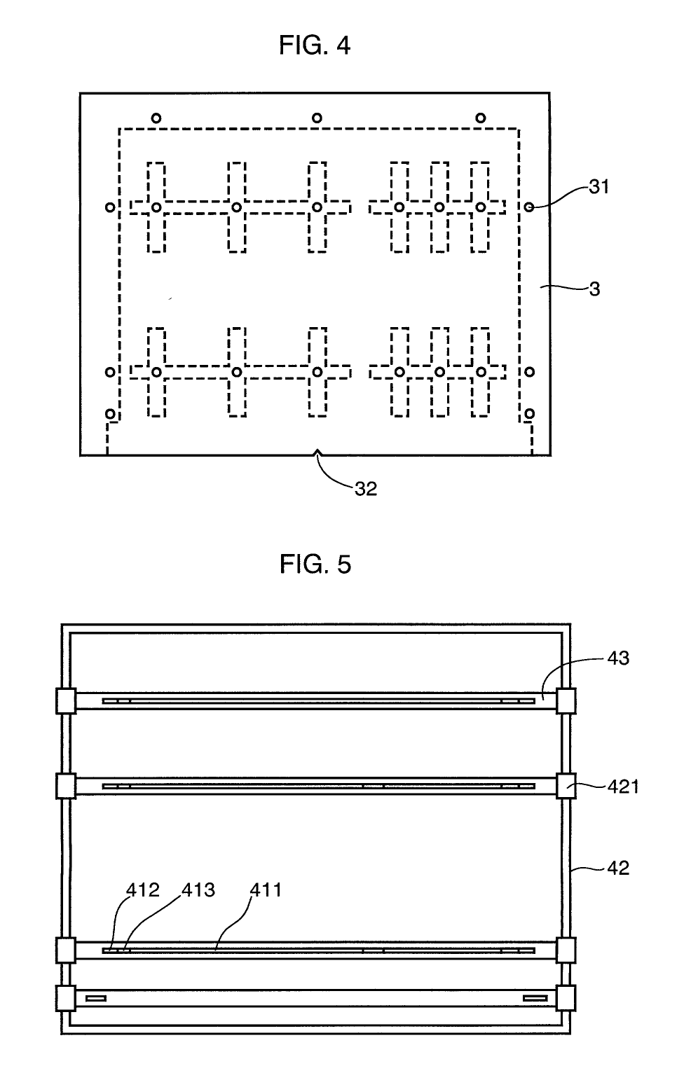

FIG. 4 is a plan view from above illustrating the positional relationship between the male die and the female die 2 (indicated by dotted lines) by putting them one upon the other. The male pins 31 are each disposed in the location where the hole 12 in the product 1 is stripped. On the gripping side, a male die centering mark 32 is provided.

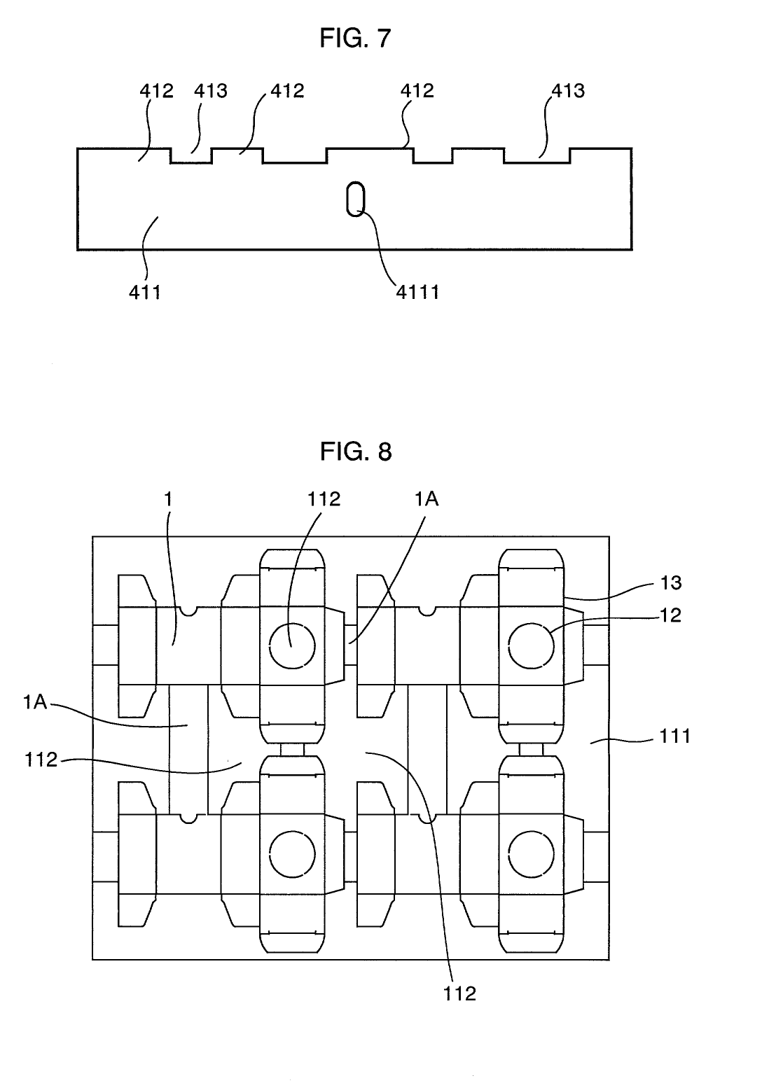

FIG. 7 shows the catching plate 411 according to the present invention that is fixed to a lower plate metallic frame 42, as illustrated in FIG. 2.

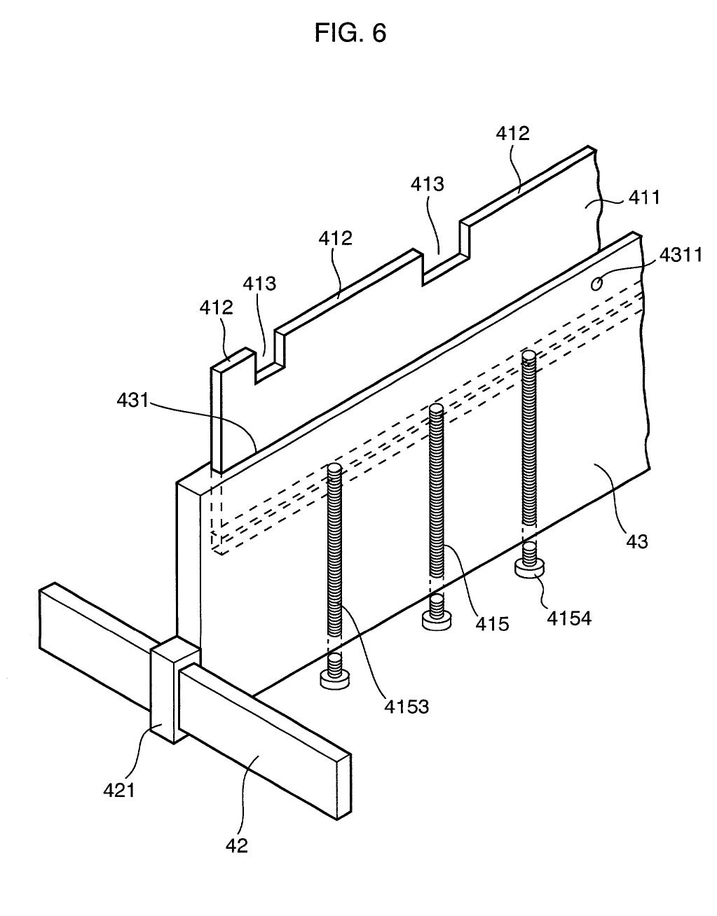

FIG. 6 specifically shows the configuration of the catching plate 411 as shown in FIG. 7. A slider 421 positioned to the blank geometry as needed is fixed to the lower plate metallic frame 42. The lower plate metallic frame 42 is secured by means of a screw (not shown) from below. The slider 421 is fixed to a lower plate receiving member 43 by welding or screwing, being fixed to the slider 421 on the opposite side. The lower plate receiving member 43 is provided with a groove 431 for receiving the catching plate 411 in the top.

The top of the catching plate 411 corresponds to the connecting grooves 22 in the female die 2, being vertically moved. In addition, the top of the catching plate 411 is provided with cutouts 413 which correspond to bridge portions 23 in the female die 2. In the inside of the lower plate receiving member 43, spring housing holes 415 each for housing a spring 4153 to vertically move the catching plate 411 are provided perpendicularly. The spring 4153 is confined by means of a confining screw 4154 at the lower end of the spring housing hole 415. In operation, the lower plate metallic frame 42 is raised, the male die 3 being lowered, and a waste 11 is sandwiched between the male pin 31 and the top of the catching plate 411. The spring 4153 presses the catching plate 411 upward to prevent the waste 11 from dropping out. Both the male pin 31 and the catching plate 411 are lowered to the bottom of the female die 2. The male die 3 is raised, the lower plate metallic frame 42 being further lowered, which results in the waste 11 being released from the male pin 31 and the catching plate 411, and dropped downward. It is recommended to reduce the thickness of the catching plate 411 to a certain degree. An optimum thickness is 0.72 mm, however, the value of thickness is not limited to this. The catching plate 411 is fully lifted by the springs 4153 so long as it is not pressed downward by the male pins 31.

In the vicinity of the respective ends of the top of the catching plate 411, a cutout 413 is provided for preventing the catching plate 411 from being contacted with the bridge portion 23 as shown in FIG. 2. Outside of the bridge portion 23, a frame removal plate 412 for stripping the external waste 111 is configured. Needless to say, the bridge portion 23 is also required, because if it were not provided, i.e., the connecting groove 22 reached the outline of the female die, the female die 2 would be divided into parts.

If the lower plate metallic frame 42 is graduated, the slider 421 can be positioned by the distance from the gripper. This scheme, of course, allows “outside setup” of the machine, eliminating the need for using the male pins 31 for alignment.

(Embodiment 2)

FIG. 8 shows another embodiment according to the present invention, in which blanks of a general direct sack box are produced by die cutting. A product 1 comprises an internal waste 112 of an internal hole 12 and an external waste 111 surrounding the blank. The product 1 and the wastes are formed by cut lines 13. To prevent the product 1 and the wastes from being disjointed when they are transferred to the subsequent stripping section after being produced in the die cutting section, they are jointed to one another by the uncut portions (not shown) which have been formed by the nicks of the cutting blade. In FIG. 8, the bottom portion provides the gripping side.

In the present embodiment, the blanking dies are designed to provide four products 1 at once. The first panel has a round hole. The blanking dies have a “two-blade” design. With the “two-blade” design, any particular product 1 is independent of the adjacent one. This type of design is often used in Japan. In Germany, the “single-blade” design (referring to a design with which any particular product 1 is connected to the adjacent one) is adopted for almost all dies. USA is in the intermediary situation. With the “two-blade” design, removing the internal wastes 112 disjoins the four blanks from one another. Then, an idea of connecting any particular product 1 to the adjacent one with a product bridge 1A arises. This idea was proposed by Daiso Kabushiki Kaisha in 1993. It is stated on p. 40 of “TOTAL PLANNING REFERENCE MANUAL/January, 1993”, a text for use in the periodical seminar held by the same company. If this idea is implemented, and the external wastes 111 and the internal wastes 112 are removed by means of the stripping device, it is only required to remove the product bridges 1 A before gluing.

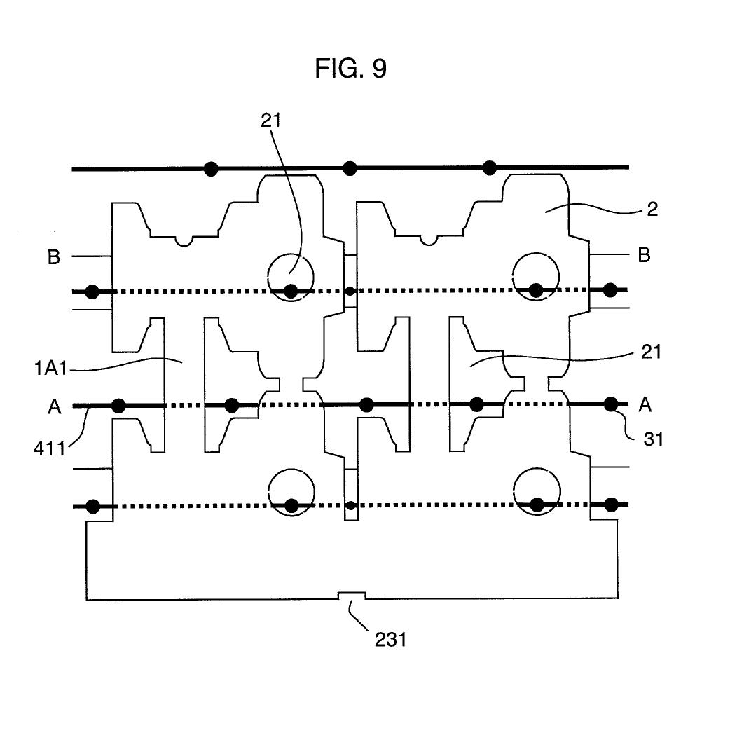

FIG. 9 is a plan view illustrating the positional relationship among a female die 2, a male pin 31 of a male die and a catching plate 411 in the present embodiment. The female die 2 is produced by cutting a plywood of 12 mm in thickness with a CO₂ gas laser to the geometry. The internal measure of a female hole 21 is greater than that of the hole 12 in product 1 by 1 mm per side. On the other hand, the outline of the female die 2, which is used for dropping off the surrounding external wastes 111, is offset by 1 mm from the outline of the product 1 toward the inside thereof. The black dot indicates the location of the male pin 31. The male pins 31 are disposed on a straight line along the X axis. FIG. 9 shows the dispositional relationship between the male pin 31 and the catching plate 411, which is raised from below to sandwich the external waste 111 of the product 1 with the male pin 31, and also to pass through the female hole 21 in the female die 2 for sandwiching the internal waste 112 of the product 1 with the male pin 31.

The top of the catching plate 411 is provided with cutouts 413. The cutouts 413 correspond to the products 1 on the female die 2. The catching plate 411 as shown in FIG. 7 is indicated by means of an line A-A in FIG. 9. The external wastes 111 and the internal wastes 112 are sandwiched between the tops of catching projections 412 and the male pins 31. On the gripping side, a centering mark 231 for the “centering system”, which has been proposed by Bobst Co. in Switzerland, is provided in the female die 2.

FIG. 6 specifically shows the configuration in which the catching plate 411 as shown in FIG. 9 is housed in a lower plate receiving member 43. A slider 421 positioned to the blank geometry as needed is fixed to a lower plate metallic frame 42. The lower plate metallic frame 42 is secured by means of a screw (not shown) from below. The slider 421 is fixed to the lower plate receiving member 43 by welding or screwing, being fixed to the slider 421 on the opposite side. The lower plate receiving member 43 is provided with a groove 431 for receiving the catching plate 411 in the top.

The top of the catching plate 411 is provided with catching projections 412 which are raised from below to pass through the female holes 21 in the female die 2 for sandwiching the wastes 112 with the male pins 31, and cutouts 413 corresponding to the product 1 for preventing the collision with the female die when the lower plate metallic frame 42 is raised. In the inside of the lower plate receiving member 43, spring housing holes 415 each for housing a spring 4153 to vertically move the catching plate 411 for positively sandwiching the wastes 112 are provided perpendicularly. The spring 4153 is confined by means of a confining screw 4154 at the lower end of the spring housing hole 415. In operation, the lower plate metallic frame 42 is raised, the catching projections 412 being raised to near the top of the female die 2 with the male die 3 being lowered, and the wastes 11 are sandwiched between the male pins 31 and the top of the catching plate 411. The springs 4153 press the catching plate 411 upward to positively hold the wastes 11 for preventing them from dropping out. Both the male pins 31 and the catching plate 411 are lowered to the bottom of the female die 2. Thus, the wastes 11 are reliably separated from the product 1. When the male die 3 reaches the bottom dead point, the male die 3 is raised, the lower plate metallic frame 42 being further lowered, which results in the wastes 11 being released from the male pin 31 and the catching plate 411, and dropped downward. It is recommended to reduce the thickness of the catching plate 411 to a certain degree. An optimum thickness is 0.72 mm, however, the value of thickness is not limited to this. The catching plate 411 is fully lifted by the springs 4153 so long as it is not pressed downward by the male pins 31.

The top of the catching plate 411 is provided with the cutouts 413 corresponding to product bridges 1A as shown in FIG. 8. Such cutouts 413 are provided to prevent collision against the product bridges 1A1 in FIG. 9. This provision is in consideration of the “two-blade” design. If such portions were not provided, the female die 2 would be divided into parts, thus, the product bridges 1A1 are indispensable.

The line B-B for the female die 2 in FIG. 9 shows a blade for cutting a large waste, especially an external waste 111 into parts.

If the lower plate metallic frame 42 is graduated, the slider 421 can be positioned by the distance from the gripper. This scheme, of course, allows “outside setup” of the machine, eliminating the need for using the male pins 31 for alignment.

In the present embodiment as shown in FIG. 9, the catching plate 411 is provided in the direction perpendicular to the gripper, however, contrarily to this, the catching plate 411 may be provided in the direction in parallel with the gripper.

### EFFECTS OF THE INVENTION

With the present inventions as described above in detail, the following effects can be obtained.

(Embodiment 1)

The present invention is configured as stated above, thus, for stripping the wastes 112 of the product 1 in FIG. 1, it is only required to mount two catching plates 411 with the present invention, compared to 12 lower pins being conventionally needed to be mounted. Therefore, the downtime for setting can be substantially shortened.

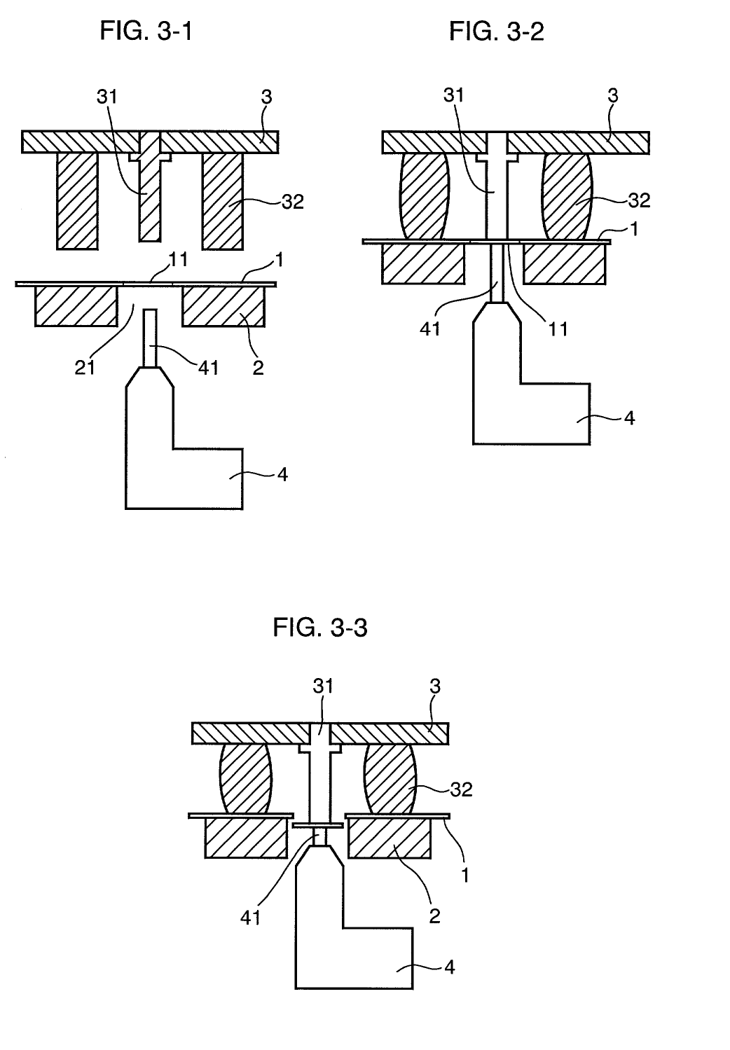

Conventionally, as illustrated in FIG. 3-1 to FIG. 3-3, when the blank geometry causes an internal waste to be small, and thus the spacing between two adjacent internal wastes 112 is small, a male pin 31 of a male die 3 can be manufactured, but it is impossible to mount receiving pins 41 on the metallic frame, because a lower pin supporter 4 is larger than the spacing. Contrarily, according to the present invention, it is only required to mount two catching plates 411.

Conventionally, the receiving pins 41 must be positioned by accurately aligning them with the male pins 31, which are already fixed, however, according to the present invention, positioning may be inaccurate, because it is only required that the male pins 31 be on the catching plate 411.

With the present invention, the connecting grooves are provided such that they are at right angles to the gripper as shown in FIG. 2, however, they may be manufactured to be in parallel with the gripper.

According to the present invention, the lower plate receiving member 43 always has a fixed length with respect to the lower plate metallic frame 42. On the other hand, the catching plate 411 may be worked to the blank geometry, being freely replaced with another type of catching plate, expendable, and capable of being manufactured inexpensively. According to the present invention, the thickness of the catching plate 411 is as small as 0.72 mm. Contrarily, the diameter of the receiving pin 41 in a conventional system is at least 3 mm. Because the catching plate 411 is in the form of a plate, it can strip substantially smaller wastes 11. According to the present invention, setting can be made outside the machine, which eliminates the need for getting in under the machine.

According to the present invention, the female die 2 has bridge portions 23, and in correspondence to this, the catching plate 411 has cutouts 413, having frame removal plates 412 on an extension line from them, thus, there is no need for mounting a separate component to strip the external wastes 111, and it is only required to position the lower plate receiving member 43 in a definite direction.

According to the present invention, the right and left external wastes 111 are simultaneously brought into contact with the male pins. Consequently, if the blank geometry causes the horizontal balance of the internal wastes to be poor, the male pins are always uniformly contacted with the internal wastes, which allows close-tolerance stripping.

The present invention is an improvement of the invention of patent application Ser. No. 2000-136446 filed by the present inventor. With the invention of patent application Ser. No. 2000-136446, the vertical movement cannot be performed smoothly because of the construction. With the present invention, if the catching plate is slightly rocked, the springs 4153 support it at the bottom, thus the catching plate is smoothly moved vertically to carry the male pins 31 reliably.

(Embodiment 2)

The present invention is configured as stated above, thus, for stripping the internal wastes 112 and the external wastes 111 of the product 1 in FIG. 8, it is only required to mount four catching plates 411 with the present invention, compared to the same number of lower pins 41 as that of the male pins 31 being conventionally needed to be mounted by getting in under the machine. Therefore, the downtime for setting can be substantially shortened.

Conventionally, the receiving pins 41 must be positioned by accurately aligning them with the male pins 31, which are already fixed, however, according to the present invention, positioning may be inaccurate, because it is only required that the male pins 31 be on the catching plate 411.

According to the present invention, the lower plate receiving member 43 always has a fixed length with respect to the lower plate metallic frame 42. On the other hand, the catching plate 411 may be worked to the blank geometry, being freely replaced with another type of catching plate, expendable, and capable of being manufactured inexpensively. To increase the convenience, a center hole 4111 is provided as shown in FIG. 7, and a pin (not shown) is penetrated through it and the center hole 4311 in FIG. 6 for allowing accurate horizontal positioning. This also prevents the catching plate 411 from dropping out. According to the present invention, the thickness of the catching plate 411 is as small as 0.72 mm. Contrarily, the diameter of the receiving pin 41 in a conventional system is at least 3 mm. Because the catching plate 411 is in the form of a plate, it can strip substantially smaller wastes 11.

According to the present invention, setting can be made outside the machine, which eliminates the need for getting in under the machine.

According to the present invention, the catching plate 411 is previously provided with cutouts 413 and catching projections 412, and is housed in the lower plate receiving member 43 in correspondence to the female holes 21 in the female die 2, thus, there is no need for mounting a separate component to strip the external wastes 111, and it is only required to position the lower plate receiving member 43 in a definite direction.

What is claimed is:

1. A stripping device for die cutting machine comprising a female die 2 which has female holes 21 corresponding to a plurality of external wastes 111 or internal wastes 112 on the same straight line; a male die 3 which has male pins 31 corresponding to the female holes 21; and a lower plate receiving member 43 for housing a catching plate 411 having pin catching projections 412 corresponding to the male pins 31, and cutouts 413 corresponding to a product 1, the lower plate receiving member 43 having spring housing holes 415 for housing springs 4153 to vertically move the catching plate 411.

2. A stripping device for die cutting machine comprising a female die 2 which has female holes 21 corresponding to a plurality of external wastes 111 or internal wastes 112 on the same straight line; a male die 3 which has male pins 31 corresponding to the female holes 21; and a lower plate receiving member 43 for housing a catching plate 411 having pin catching projections 412 corresponding to the male pins 31, and cutouts 413 corresponding to a product 1 and/or a product bridge 1A, the lower plate receiving member 43 having spring housing holes 415 for housing springs 4153 to vertically move the catching plate 411.

3. A stripping device for die cutting machine comprising a female die 2 which has a connecting groove 22 for connecting a plurality of female holes 21 to strip a plurality of internal wastes 112 and bridge portions 23 on an extension line from both ends thereof, and a lower plate receiving member 43 for housing a catching plate 411 having cutouts 413 corresponding to the connecting groove 22 and the bridge portions 23, the lower plate receiving member 43 having spring housing holes 415 for housing springs 4153 to vertically move the catching plate 411.
